(19) United States
(12) Patent Application Publication
(10) Pub. No.: US 2007/0069578 A1
(43) Pub. Date: Mar. 29, 2007

(54) Method for shortening a stopping distance

(75) Inventors: Peter Hille, Stuttgart (DE); Wolfgang Lauer, Heilbronn (DE); Thomas Rohrig-Gericke, Weil im Schonbuch (DE); Ralph Scharpf, Stuttgart (DE)

Correspondence Address: FITCH, EVEN, TABIN & FLANNERY, P. O. BOX 18415, WASHINGTON, DC, 20036, US

(73) Assignee: DaimierChrysler AG, Epplestrasse 225 (DE)

(21) Appl. No.: 10/580,212

(22) PCT Filed: Nov. 11, 2004
(86) PCT No.: PCT/EP04/12771

§ 371 Date: Aug. 9, 2006

(30) Foreign Application Priority Data
Nov. 26, 2003 (DE) 10355219.7

(51) Int. Cl. B60T 8/32

(52) U.S. Cl. 303/191

(57) ABSTRACT

In a method for shortening the stopping distance of a vehicle (2), in which a braking operation is prepared when a predefined event occurs, the braking operation is prepared if a driving situation which is implausible to a driving assistance system occurs. This permits traffic safety to be improved.

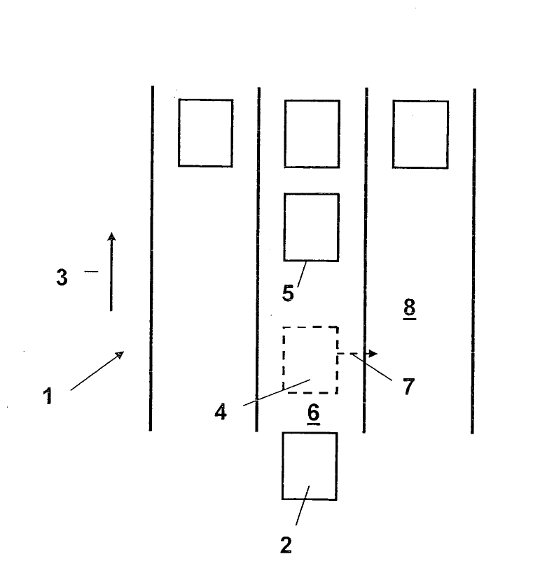

The invention relates to a method for shortening the stopping distance of a vehicle, in which a braking operation is prepared when a predefined event occurs.

When braking in emergency situations, a driver must firstly overcome the venting play in the brakes until a brake pressure can be built up in order to bring about a perceptible deceleration of the vehicle. This takes time and makes the stopping distance longer. In order to reduce this so-called threshold time it is possible to pre-charge the brake with a slight pressure which still does not bring about any perceptible deceleration. When the brake is actuated by the driver it is then not necessary to overcome any further venting play. An event at whose occurrence the brake is pre-charged constitutes, for example, the rapid removal of the driver's foot from the accelerator pedal. A large number of situations in which it is appropriate to pre-charge the brake or to build up a certain braking pressure are not covered by this event or the monitoring of the accelerator pedal.

EP 1081004 A2 discloses a sensing system of a vehicle which detects obstacles in the direction of travel or near to the direction of travel of the vehicle. Sensors which are mounted on the vehicle supply characteristic parameters for the state of the vehicle. Furthermore, sensors are assigned to the brake pedal and the accelerator pedal. A control unit determines, on the basis of the data supplied by the sensing system, whether a braking operation is necessary. Furthermore, the control unit determines a desired “stand-by braking pressure”. This system can accordingly bring about a shortening in the stopping distance if objects are detected in the area in front of the vehicle.

The object of the present invention is to develop a method of the type mentioned at the beginning in such a way that it is possible to shorten the stopping distance in additional driving situations.

This object is achieved according to the invention in that in a method of the type mentioned at the beginning the braking operation is prepared if a driving situation which is implausible to a driving assistance system occurs.

Driving assistance systems are used, for example, for inter-vehicle distance control with respect to a vehicle travelling in front. In particular it is possible to provide for a driving assistance system to adjust the speed of the vehicle to a set speed which is set by the driver if a stationary object or slowly travelling object is not detected in the area in front of the vehicle. If such an object is detected, the distance between the vehicle and the vehicle travelling in front is adjusted and/or the vehicle is guided behind the vehicle travelling in front. An implausible driving situation occurs, for example, if there is a sudden loss of the object when the distance from a vehicle travelling in front, which is the relevant object, is being automatically adjusted. If such a loss of an object is detected, a hazardous situation may have occurred. According to the invention, in such a case a braking operation is prepared so that in the event of a braking operation being necessary a short stopping distance is brought about. A loss of an object also occurs if an object travelling in front can no longer be sensed owing to soiled sensors.

A further example of an implausible driving situation is when a vehicle which the driving assistance system is using for orientation cuts out of the lane. In such a case, the driving assistance system must firstly form a new relevant object again, for example, the object which is travelling in front of the vehicle which cuts out of the lane. Also, if a stationary obstacle suddenly appears, for example a vehicle which is stationary in a traffic jam, in front of a vehicle which is cutting out of the lane, this gives rise to an implausible driving situation which cannot be resolved by the driving assistance system.

This means that a reduction in the stopping distance is also possible in driving situations in which the reaction of the driver does not allow an emergency braking situation to be inferred. In particular, a braking operation can be prepared even before the driver takes his foot off the accelerator pedal.

The driving according to the invention is not a safety/critical application since the braking is only prepared. This leads to no appreciable deceleration. It is particularly advantageous that the reaction speed of the brake system when an assistance system is switched off and the control of the vehicle is assumed by the driver is improved. A particular advantage is the use of the method in dynamic driving situations which make more stringent requirements of the driver's reactions, for example in the stop and go mode or in town traffic. The method according to the invention can be implemented easily without additional hardware components being necessary on a vehicle.

In one preferred method variant, a pilot braking pressure is generated in order to prepare the braking operation. Such a pilot braking pressure causes the venting play of the brake to be overcome and no further venting play has to be overcome by the driver when the brake is activated. The brake system therefore reacts considerably more quickly to the braking instruction from the driver.

In one preferred development there is provision for a speed-dependent pilot braking pressure to be generated.

In particular at high speeds it is possible to generate a higher pilot braking pressure since slight braking of the vehicle is perceived to a lesser extent by the driver. This measure enables the braking from high speeds to be accelerated and the braking distance of the vehicle to be reduced. The pilot braking pressure is preferably selected in such a way that the venting play of the brake is just overcome without a perceptible braking operation being carried out.

A braking operation can also be prepared if the driver is requested by a driving assistance system to assume the control of the vehicle and/or to brake. The request to assume the control of the vehicle is issued, for example, if the speed of the vehicle drops below a switch-on threshold of the driving assistance system below which the assistance system can no longer support the driver. Such a low speed can may mean that the vehicle has to be braked to an even greater degree. Pre-charging the brakes shortens the braking distance in such a situation.

The braking operation is advantageously prepared if a driving assistance system is deactivated. If, for example, an object which is relevant for the driving assistance system is lost, the driving assistance system is at least temporarily deactivated as long as a new relevant object is being sought. During this time interval it is possible for a situation to occur which requires braking. Furthermore, it is conceivable that an assistance system deactivates itself since a situation has occurred with which it cannot cope, for example if a vehicle traveling in front cuts out of its lane and the vehicle is suddenly located in the direct vicinity of the end of a traffic jam. In such a case rapid braking is necessary and the stopping distance can be considerably shortened by initiating the braking operation. A braking operation can also be initiated if the driving assistance system is deactivated by the driver.

In one method variant it is possible to provide that objects are sensed at least in the area in front of the vehicle. If an object is detected in the area in front of the vehicle, i.e. in the direction of travel in front of the vehicle, it is possible to detect, by means of a corresponding evaluation, whether a braking process could be necessary. In such a case it is possible to prepare a braking operation irrespective of whether an assistance function is activated or deactivated.

In one advantageous method variant the distance and/or the relative speed and/or the relative acceleration with respect to an object in the area in front of the vehicle are determined and if the value drops below or exceeds a reference distance, a reference relative speed or a reference acceleration the braking operation is prepared. The measurement of the distance and of the speeds is preferably carried out by what are referred to as short-range radar sensors. If the critical approach of an object is detected, a braking operation can be prepared, in particular the brakes can be automatically pre-charged. Since this does not lead to any appreciable deceleration, the preparation of the braking operation can also occur if no assistance system is active.

The method according to the invention can be implemented using software or hardware and can be carried out by a computing unit which is correspondingly configured in terms of programming technology.

Further features and advantages of the invention emerge from the subsequent description of an exemplary embodiment of the invention, by reference to the figures of the drawing which show details which are essential to the invention, and from the claims. The individual features can each be implemented individually or in any desired combination in a variant of the invention.

Exemplary embodiments of the invention are explained in more detail with reference to a drawing. The only FIGURE of the drawing shows a schematic representation for explaining the method.

The figure shows a plan view of a three-lane road 1 on which the vehicle 2 travels in the direction 3 of travel. The driver of the vehicle 2 is supported by a driving assistance system which adjusts the distance of the vehicle 2 from the vehicle 4 traveling in front in such a way that a critical, speed-dependent minimum distance is not undershot. If the vehicles 2, 4 approach a stationary vehicle 5 which represents the end of a traffic jam on the lane 6, the driving assistance system is deactivated if the vehicle 4 cuts out onto the adjacent lane 8 in the direction 7 of the arrow. The driving assistance system requests the driver to assume control of the vehicle since a situation has occurred which the driving assistance system cannot resolve. The driver only has a short time to bring the vehicle 2 to a standstill before the end of the traffic jam. For this reason, a braking operation of the vehicle 2 is prepared by generating a slight braking pressure in order to overcome the venting play of the brake at the same time as the transfer request is issued so that the stopping distance of the vehicle 2 is shortened when the driver activates the brake.

1. A method for shortening the stopping distance of a vehicle (2), in which a braking operation is prepared when a predefined event occurs, characterized in that the braking operation is prepared if a driving situation which is implausible to a driving assistance system occurs.

2. The method as claimed in claim 1, characterized in that a pilot braking pressure is generated in order to prepare the braking operation.

3. The method as claimed in claim 2, characterized in that a speed-dependent pilot braking pressure is generated.

4. The method as claimed in claim 1, characterized in that the braking operation is prepared if the driver is requested by a driving assistance system to assume the control of the vehicle and/or to brake.

5. The method as claimed in claim 1, characterized in that the braking operation is prepared if a driving assistance system is deactivated.

6. The method as claimed in claim 1, characterized in that objects are sensed at least in the area in front of the vehicle.

7. The method as claimed in claim 1, characterized in that the distance and/or the relative speed and/or the relative acceleration with respect to an object in the area in front of the vehicle are determined and if the value drops below or exceeds a reference distance, a reference relative speed or a reference acceleration the braking operation is prepared.

8. A computing unit which is configured in terms of programming technology to carry out the method as claimed in claim 1.
